(19) United States
(12) Patent Application Publication
(10) Pub. No.: US 2024/0416325 A1
(43) Pub. Date: Dec. 19, 2024

(54) FUNCTIONAL NANOSCALE METAL OXIDES FOR STABLE METAL SINGLE ATOM AND CLUSTER CATALYSTS

(71) Applicants: Jingyue Liu, Scottsdale, AZ (US); Xu Li, Tempe, AZ (US)

(72) Inventors: Jingyue Liu, Scottsdale, AZ (US); Xu Li, Tempe, AZ (US)

(21) Appl. No.: 18/815,151

(22) Filed: Aug. 26, 2024

Related U.S. Application Data
(63) Continuation of application No. 18/233,568, filed on Aug. 14, 2023, now Pat. No. 12,102,989.
Application No. 18/233,568 is a continuation of application No. 16/897,871, filed on Jun. 10, 2020, now Pat. No. 11,766,663.
(60) Provisional application No. 62/876,437, filed on Jul. 19, 2019.

(51) Int. Cl. B01J 23/75; B01J 23/10; B01J 23/42; B01J 23/44; B01J 23/72; B01J 23/745; B01J 35/23; B01J 35/61; B01J 37/02; C01B 3/16; C01B 3/32; C01B 3/40; C01B 32/50

(52) U.S. Cl. CPC B01J 23/75; B01J 23/10; B01J 23/42; B01J 23/44; B01J 23/72; B01J 23/745; B01J 35/23; B01J 35/613; B01J 37/0221; C01B 3/16; C01B 3/326; C01B 3/40; C01B 32/50; C01B 2203/0233; C01B 2203/0261; C01B 2203/0283; C01B 2203/107; C01B 2203/1082; C01B 2203/1223; C01B 2203/1241

(57) ABSTRACT

A nanocomposite catalyst includes a support, a multiplicity of nanoscale metal oxide clusters coupled to the support, and one or more metal atoms coupled to each of the nanoscale metal oxide clusters. Fabricating a nanocomposite catalyst includes forming nanoscale metal oxide clusters including a first metal on a support, and depositing one or more metal atoms including a second metal on the nanoscale metal oxide clusters. The nanocomposite catalyst is suitable for catalyzing reactions such as CO oxidation, water-gas-shift, reforming of CO₂ and methanol, and oxidation of natural gas.

### CROSS-REFERENCE TO RELATED APPLICATIONS

This application is a continuation of U.S. patent application Ser. No. 18/233,568 entitled “FUNCTIONAL NANOSCALE METAL OXIDES FOR STABLE METAL SINGLE ATOM AND CLUSTER CATALYSTS” and filed on Aug. 14, 2023, which is a continuation of U.S. patent application Ser. No. 16/897,871 entitled “FUNCTIONAL NANOSCALE METAL OXIDES FOR STABLE METAL SINGLE ATOM AND CLUSTER CATALYSTS” and filed on Jun. 10, 2020, now U.S. Pat. No. 11,766,663, and claims the benefit of U.S. Patent Application No. 62/876,437 entitled “FUNCTIONAL NANOGLUES FOR STABLE METAL SINGLE ATOM AND CLUSTER CATALYSTS” and filed on Jul. 19, 2019, the disclosure of each are hereby incorporated by reference in their entirety.

### STATEMENT OF GOVERNMENT SUPPORT

This invention was made with government support under 1465057 awarded by the National Science Foundation. The government has certain rights in the invention.

### TECHNICAL FIELD

This invention relates to functional nanoscale metal oxide for stable metal single atom and cluster catalysts.

### BACKGROUND

Supported metal catalysts are used in many important catalytic reactions for producing chemicals and energy or for environmental remediation. Since catalysis is a surface reaction process, the use of smaller metal particles can save cost and/or yield better catalytic selectivity/activity. However, smaller metal particles, clusters or single atoms are not thermodynamically stable and usually sinter to form larger particles during a catalytic reaction, especially at elevated temperatures and under a reducing environment. For relatively high temperature catalytic reactions (e.g., control of emissions from automobiles and stationary sources), the high-surface-area supports generally need to be able to resist sintering at high temperatures. Such inert refractory support materials (e.g., SiO₂, Al₂O₃, etc.) have been used as sintering resistant high-surface-area supports, but typically do not strongly anchor metal clusters or single metal atoms.

### SUMMARY

As described herein, nanoscale metal oxides are used to strongly bind the metal atoms or clusters and high-surface-area refractory supports. A facile and scalable wet chemistry synthesis approach is developed to deposit reducible nanoscale metal oxides, or “nanoislands,” onto high-surface-area refractory oxide supports, and preferentially deposit metal atoms or clusters onto only the reducible metal oxide nanoislands but not onto the high-surface-area refractory oxide support surfaces. Such supported metal atom or cluster catalysts proved extremely stable and active for a variety of catalytic reactions. The reducible metal oxide nanoislands localize metal atoms or clusters to prevent sintering, and provide desirable catalytic function(s) during a targeted catalytic reaction.

This disclosure relates to the use of nanoscale metal oxides as “nanoislands” that can bind strongly to metal atoms or clusters as well as high-surface-area refractory supports. The metal oxide nanoislands typically have a dimension (e.g., diameter or height) of 0.5 nm to 10 nm. In some cases, the metal oxide nanoislands having a dimension of 0.5 nm up to 3 nm are referred to as “nanoglues,” while the metal oxide nanoislands having a dimension of 3 nm to 10 nm are referred to as “nanoparticles” or “nanocrystals.” In some embodiments, metal atoms, clusters, or particles are deposited on refractory support surfaces on which a nanoscale metal oxide has been dispersed, thereby strongly binding the metal species. The individual metal oxide nanoislands are isolated from each other. This approach allows scalable manufacturing of sintering resistant atomically dispersed metal catalysts. Many types of reducible metal oxides may be utilized to produce metal oxide nanoislands. The choice of suitable metal oxides depends on the specific catalytic reaction of interest. In this case, the nanoislands possess their own function (e.g., providing readily available active surface and/or lattice oxygen species) during a catalytic reaction. To construct a stable atomically dispersed or cluster catalyst, any metal species, including noble metal species, can be used. The nanoislands can include one or more reducible metal oxides. Suitable high-surface-area refractory supports include silica, alumina, magnesia, zirconia, combinations of these, and other appropriate materials such as cordierite and perovskite-type oxides. In one example, CeOₓ, a highly reducible metal oxide, is used as a nanoisland, and high-surface-area SiO₂ is used as the support material. Through a facile and scalable wet chemistry synthesis method, Pt single atoms, clusters, or nanoparticles are preferentially deposited onto the CeOₓ nanoisland to produce a Pt₁/CeOₓ—SiO₂ single-atom catalyst or Ptₙ/CeOₓ—SiO₂ cluster catalyst. Such catalysts have proven to be extremely active and stable for CO oxidation reaction, even at temperatures below 150° C.

In a first general aspect, a nanocomposite catalyst includes a support, a multiplicity of nanoscale metal oxide clusters coupled to the support, and one or more metal atoms coupled to each of the nanoscale metal oxide clusters.

Implementations of the first general aspect may include one or more of the following features.

The support may include a refractory material having a surface area of at least 50 m²/g or at least 100 m²/g. Suitable examples of support materials include silica, alumina, magnesia, zirconia or any combination thereof. The support can be powdered.

The nanoscale metal oxide clusters typically have a dimension in a range of 0.5 nm to 10 nm. The nanoscale metal oxide clusters may include CeOₓ, CoOₓ, FeOₓ TiOₓ, CuOₓ, NiOₓ, MnOₓ, NbOₓ, VOₓ, ZrOₓ, or any combination thereof. In some cases, the nanoscale metal oxide clusters include CeO₂, Co₃O₄, Fe₂O₃, TiO₂, CuO, NiO, MnO₂, Nb₂O₅, V₂O₅, ZrO₂, or any combination thereof.

The one or more metal atoms can include metal clusters (e.g., metal clusters having 2 to 100 metal atoms). In some cases, the one or more metal atoms independently include one or more transition metal atoms, one or more precious metal atoms, or both. Examples of suitable metal atoms include Pt, Pd, Rh, Au, Ru, Ir, or any combination thereof.

The support is substantially free of direct contact with the one or more metal atoms. In some examples, the support includes SiO₂ and the metal oxide clusters include CeOₓ, CoOₓ, CuOₓ, FeOₓ, or any combination thereof.

In a second general aspect, fabricating a nanocomposite catalyst includes forming nanoscale metal oxide clusters including a first metal on a support, and depositing one or more metal atoms including a second metal on the nanoscale metal oxide clusters.

Implementations of the second general aspect may include one or more of the following features.

The first metal and the second metal may be the same or different. The one or more metal atoms may independently include one or more transition metal atoms, one or more precious metal atoms, or any combination thereof. In some cases, the nanoscale metal oxide clusters include CeOₓ, CoOₓ, FeOₓ TiOₓ, CuOₓ, NiOₓ, MnOₓ, NbOₓ, VOₓ, ZrOₓ (e.g., CeO₂, Co₃O₄, Fe₂O₃, TiO₂, CuO, NiO, MnO₂, Nb₂O₅, V₂O₅, ZrO₂), or any combination thereof. The support is typically free or substantially free of direct contact with the second metal. In some cases, the support includes a refractory material having a surface area of at least 50 m²/g or at least 100 m²/g.

In a third general aspect, catalyzing a reaction includes contacting the nanocomposite catalyst of the first general aspect with reactants, wherein the reaction comprises CO oxidation, water-gas-shift reaction, reforming of CO₂ and methanol, or oxidation of natural gas.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1A-1C depict a single metal atom, two different single metal atoms, and a metal cluster, respectively, anchored onto the surface of a reducible metal oxide nanoisland bound to the surface of a refractory oxide support.

FIG. 2A depicts solution deposition of positively charged metal complexes onto the negatively charged surfaces of a refractory oxide support. FIG. 2B depicts formation of uniformly deposited metal complexes onto the surface of a refractory oxide support. FIG. 2C depicts formation of individually isolated reducible metal oxide nanoisland by a high temperature calcination process.

FIG. 3A depicts a process for solution deposition of negatively charged metal species onto the positively charged surfaces of the reducible metal oxide nanoisland, but not onto the negatively charged surfaces of the refractory oxide support. FIG. 3B depicts a single metal atom which deposits on the reducible metal oxide nanoisland which is supported on the refractory oxide support after washing, drying, and calcining processes.

FIG. 4A shows a representative low-magnification high-angle annular dark-field-scanning transmission electron microscopy (HAADF-STEM) image of CeOₓ nanoislands uniformly distributed throughout a high-surface-area SiO₂ support. FIG. 4B shows a representative high-magnification HAADF-STEM image of CeOₓ nanoislands.

FIG. 5 shows a histogram of the particle size distribution of the CeOₓ nanoislands obtained by analyzing high resolution HAADF-STEM images.

FIG. 6 shows powder X-ray diffraction (XRD) patterns obtained from 12 wt % CeOₓ nanoislands supported on SiO₂ and 12 wt % CeO₂ nanoparticles supported on SiO₂.

FIG. 7A shows Ce 3d X-ray photoelectron spectroscopy (XPS) spectra recorded over SiO₂ supported CeOₓ nanoislands. FIG. 7B shows Ce 3d XPS spectra recorded over SiO₂ supported CeO₂ nanoislands.

FIG. 8 shows Raman spectra obtained over SiO₂ supported CeOₓ and CeO₂ nanoislands.

FIG. 9A shows a representative low-magnification HAADF-STEM image of CoOₓ nanoislands uniformly distributed throughout the high-surface-area SiO₂ support. FIG. 9B shows a representative high-magnification HAADF-STEM image of CoOₓ nanoislands.

FIG. 10A shows a representative low-magnification HAADF-STEM image of CuOₓ nanoislands uniformly distributed throughout the high-surface-area SiO₂ support. FIG. 10B shows a representative high-magnification HAADF-STEM image of CuOₓ nanoislands.

FIG. 11A shows a representative low-magnification HAADF-STEM image of FeOₓ nanoislands uniformly distributed throughout the high-surface-area SiO₂ support. FIG. 11B shows a representative high-magnification HAADF-STEM image of FeOₓ nanoislands.

FIG. 12A shows a representative low-magnification HAADF-STEM image of a typical Pt₁/CeOₓ—SiO₂ single-atom catalyst revealing the absence of Pt nanoparticles and nanoclusters. FIG. 12B shows a representative high-magnification HAADF-STEM image of a typical Pt₁/CeOₓ—SiO₂ single-atom catalyst showing the absence of Pt nanoparticles and nanoclusters.

FIG. 13A shows a representative HAADF-STEM image of a typical CeOₓ—SiO₂ supported Pt cluster catalyst. FIG. 13B shows a representative HAADF-STEM image of a typical CeOₓ—SiO₂ supported Pt nanoparticle catalyst.

FIG. 14A shows a representative low-magnification HAADF-STEM image of a typical Pd₁/CeOₓ—SiO₂ single-atom catalyst showing the absence of Pd nanoparticles and nanoclusters. FIG. 14B shows a representative high-magnification HAADF-STEM image of a typical Pd₁/CeOₓ—SiO₂ single-atom catalyst showing the absence of Pd nanoparticles and nanoclusters.

FIG. 15 shows conversion rate of CO oxidation over the 0.05 wt % Pt₁/CeOₓ—SiO₂ single-atom catalyst and the CeOₓ—SiO₂ support control.

FIG. 16 shows conversion rate of CO oxidation over the 0.05 wt % Pt₁/CeOₓ—SiO₂ before and after H₂ reduction treatment.

FIG. 17 shows conversion rate of CO oxidation over the 0.05 wt % Pd₁/CeOₓ—SiO₂ before and after H₂ reduction treatment.

FIG. 18 shows conversion rate of CO oxidation over Au/CeOₓ—SiO₂ catalyst.

FIG. 19 shows a stability test of CO oxidation over the 0.05 wt % Pt₁/CeOₓ—SiO₂ single-atom catalyst.

FIG. 20 shows a stability test for CO oxidation over the 0.05 wt % Pd₁/CeOₓ—SiO₂ single-atom catalyst.

FIG. 21 shows a stability test for CO oxidation over the Au/CeOₓ—SiO₂ catalyst.

FIG. 22 shows a conversion rate of water-gas-shift reaction (WGS) over the 0.05 wt % Pt₁/CeOₓ—SiO₂ single-atom catalyst.

FIG. 23 shows a stability test of WGS over the 0.05 wt % Pt₁/CeOₓ—SiO₂ single-atom catalyst.

FIG. 24 shows a conversion rate for methanol steam reforming over the 0.2 wt % Pt₁/CeOₓ—SiO₂ catalyst.

FIG. 25A depicts high-number density of Pt₁ atoms supported on CeOₓ—SiO₂ nanoislands which are supported on high-surface-area refractory material. FIG. 25B shows HAADF-STEM images of a typical Pt₁/CeOₓ—SiO₂ single-atom catalyst showing spatial distribution of the CeOₓ nanoislands. FIG. 25C shows the atomic structure of the CeOₓ clusters. The Pt₁ atoms cannot be reliably identified due to lack of proper image contrast. FIG. 25D shows catalytic testing data for CO oxidation on various types of catalysts.

### DETAILED DESCRIPTION

Extremely stable supported metal atom and cluster catalysts have been developed by judicially integrating metal atoms (e.g., noble metal atoms), reducible metal oxides, and refractory high-surface-area supports. Atomically dispersed metal atoms and clusters are stabilized by use of nanoscale metal oxides (“nanoislands”) attached to refractory support materials. The reducible metal oxides serve as a binder to confine the movement of supported metal atoms or clusters during catalytic reactions. The reducible nanoscale metal oxides not only stabilize metal atoms and clusters during a catalytic reaction at high temperatures but also provide desirable functions to enhance the activity of a desired catalytic reaction. The nanoscale metal oxides typically have a dimension (e.g., diameter or height) of 0.5 nm to 10 nm. In some cases, the nanoscale metal oxides having a dimension of 0.5 nm up to 3 nm are referred to as “nanoglues,” while the nanoscale metal oxides having a dimension of 3 nm to 10 nm are referred to as “nanoparticles” or “nanocrystals.”

The type of metal can be any transition metal (e.g., precious metal). Suitable metal oxides include CeOₓ (e.g., CeO₂), CoOₓ (e.g., Co₃O₄), FeOₓ (e.g., Fe₂O₃), TiOₓ (e.g., TiO₂), CuOₓ (e.g., CuO), NiOₓ (e.g., NiO), MnOₓ (e.g., MnO₂), NbOₓ (e.g., Nb₂O₅), ZrOₓ (e.g., ZrO₂) combinations of these oxides, and other appropriate meal oxides. A typical dimension for the nanoscale reducible metal oxide (e.g., diameter or height) is in a range of 0.5 nm to 10 nm. Suitable high-surface-area refractory support materials include SiO₂, Al₂O₃, MgO, ZrO₂, combinations of these oxides, and other appropriate support materials (e.g., mullite, cordierites, or perovskites).

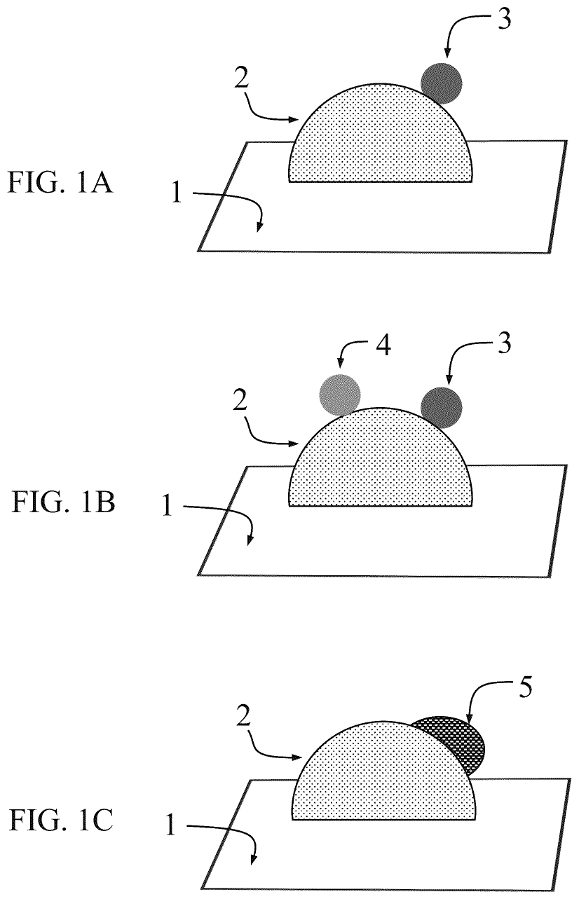

The utilization of such manufactured stable catalysts has been tested for CO oxidation, water-gas-shift reaction, reforming of CO₂ and methanol, oxidation of natural gas, and the like. The catalyst design and synthesis strategy described herein is schematically illustrated in FIGS. 1-3.

FIG. 1A depicts a single metal atom 3 preferentially anchored onto the surface of a reducible nanoscale metal oxide 2, which strongly binds onto the surface of a high-surface-area refractory oxide support 1. As used herein, “high surface area” generally refers to at least 50 m²/g or at least 100 m²/g. FIG. 1B depicts a single metal atom 3 and a different single metal atom 4 which are preferentially anchored onto the surface of a reducible nanoscale metal oxide 2 that strongly binds onto the surface of a refractory oxide support 1. The single metal atoms 3 and 4 can be associated with each other or independently anchored onto the surface of a reducible nanoscale metal oxide 2. FIG. 1C depicts a cluster of metal atoms (e.g., 2 to 100 metal atoms) 5 which is preferentially anchored onto the surface of a reducible nanoscale metal oxide 2 that strongly binds onto the surface of a high-surface-area refractory oxide support 1. The cluster 5 can include a single metal, a bimetallic alloy, or combinations of two or more metals. Suitable refractory oxide supports include SiO₂, Al₂O₃, MgO, ZrO₂, other appropriate materials, or any combination thereof (e.g., mullite and cordierite). Suitable nanoscale metal oxides include reducible oxide nanoclusters such as CeOₓ, CoOₓ, TiOₓ, FeOₓ, CuOₓ, MnOₓ, NbOₓ, ZrOₓ, other appropriate oxides, or any combination thereof. The reducible oxide nanoclusters typically have a dimension (e.g., diameter or height) of 0.5 nm to 10 nm. In some cases, nanoclusters having a dimension of 0.5 nm up to 3 nm are referred to as “nanoglues,” while nanoclusters having a dimension of 3 nm to 10 nm are referred to as “nanoparticles” or “nanocrystals.” Suitable metals for the metal atoms include precious metals (e.g., Pt, Pd, Rh, Au, Ru, Ir, Ag, and the like), transition metals, or any appropriate metal or alloy cluster with a total number of atoms in a range of 2 to 200 (e.g., 2 to 100 or 3 to 10).

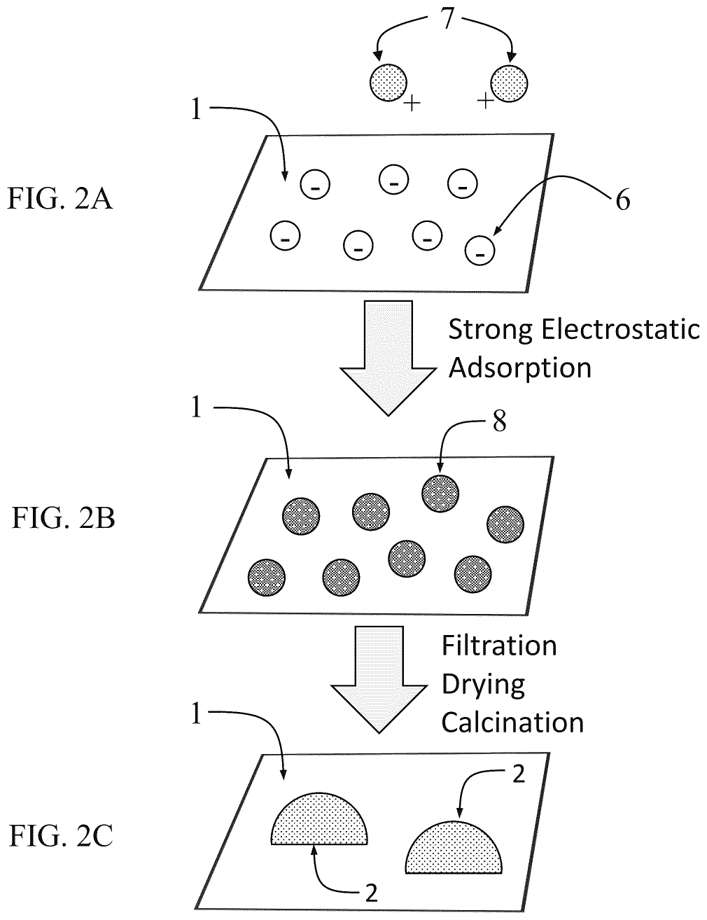

FIG. 2A depicts solution deposition of positively charged metal complexes 7 onto the surface of a high-surface-area refractory oxide support 1 that are negatively charged 6 due to the presence of surface species in aqueous solution at the appropriate pH. FIG. 2B depicts formation of uniformly deposited metal complexes 8 onto the surfaces of the high-surface-area refractory support 1 via strong electrostatic adsorption processes. FIG. 2C depicts formation of individually isolated reducible metal oxide nanoisland glue 2, by a high temperature calcination process, uniformly covering the surfaces of the high-surface-area refractory oxide support 1.

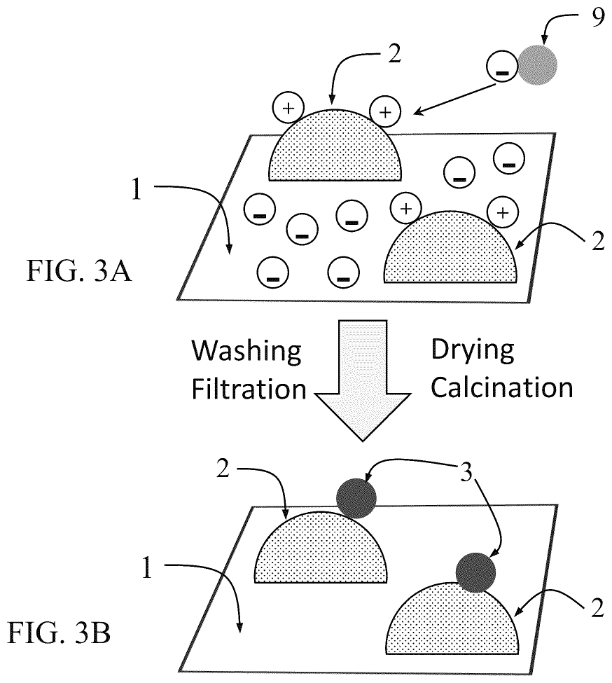

FIG. 3A depicts a process for preferential solution deposition of metal atoms 9 onto the surfaces of the reducible metal oxide nanoisland glue 2, but not onto the surface of the high-surface-area refractory oxide support 1. By tuning the solution pH value, the refractory oxide support 1 can be made negatively charged while the reducible metal oxide nanoisland glue 2 becomes positively charged. The negatively charged metal complex 9 then can typically only deposit onto the positively charged reducible metal oxide nanoisland glue 2 due to strong electrostatic attraction but cannot typically deposit onto the negatively charged refractory oxide support 1 due to strong repulsion. FIG. 3B depicts single metal atom 3 which deposits on the nanoscale metal oxide 2 which are attached to the refractory oxide support 1 after washing, drying, and calcining processes.

The specific synthesis examples illustrated below follow the general principles of the design strategy. Reducible metal oxide nanoislands are used as functional nanoglues. The reducible nanoscale metal oxides are synthesized by a facile wet chemical synthesis route. Specifically, metal complexes are solution deposited onto the refractory support surfaces by a strong electrostatic adsorption method. High temperature calcination of the deposited species produces isolated individual nanoscale metal oxide islands strongly attached to the refractory support surfaces. The metal atoms and/or clusters are preferentially deposited onto the surfaces of the isolated individual nanoscale metal oxides but not onto the surfaces of the refractory support materials by fine tuning the solution pH so that the nanoscale metal oxide surfaces maintain a surface charge that is opposite to that of the deposited metal complexes, and the refractory support surfaces maintain a surface charge similar to that of the deposited metal complexes.

Atomically dispersed metal atoms and clusters are stabilized by use of nanoscale metal oxides. The synthesis processes include dispersing metal oxide clusters (e.g., 1 nm to 2 nm CeOₓ clusters) on a support (e.g., SiO₂) and then depositing single metal atoms (e.g., Pt) onto the metal oxide clusters. Extremely stable supported metal atom and cluster catalysts can be prepared by judicially integrating metal atoms (e.g., noble metal atoms), reducible metal oxide nanoglues, and refractory high-surface-area supports. The use of reducible nanoscale metal oxides stabilizes metal atoms and clusters during a catalytic reaction at high temperatures and provides desirable functions (e.g., providing readily available active surface and/or lattice oxygen species) to enhance the activity of a desired catalytic reaction.

Specific examples of facile and scalable wet chemistry methods to manufacture supported metal atom and cluster catalysts that are resistant to sintering, even at elevated temperatures and under various gas environment, are described below. In some embodiments, reducible metal oxide nanoislands strongly glue the metal atoms/clusters to a high-surface-area refractory support which can resist sintering at high temperatures. The zeta potential of different materials can be utilized to preferentially deposit metal atoms or clusters only to the reducible metal oxide nanoislands. The synthesis process is low cost, scalable, and ready for large scale manufacturing.

CO oxidation is used as a probe reaction to evaluate the stability of the prepared supported metal atom and cluster catalysts. For a Pt₁/CeOₓ—SiO₂ single-atom catalyst (SAC) system, results demonstrate that the CeOₓ clusters stabilize the Pt₁ single atoms during the CO oxidation and also enhance the activity, presumably due to the redox capability of CeOₓ clusters that facilitate CO oxidation.

### EXAMPLES

### Synthesis of CoOₓ—SiO₂

180 mg of fumed SiO₂ powder (surface area of 278 m²/g) was dispersed into 30 mL of water by sonication. 54 mg of hexamminecobalt (III) chloride was dissolved into 20 mL of ammonia solution (concentration of NH₃·H₂O was 5 mol/L). Under rigorous stirring, the Co precursor was quickly injected into the SiO₂ solution. The mixture was aged under stirring for 1 h and then the precipitate was collected by vacuum filtration. The resultant orange Co—SiO₂ precipitates were removed for air dry overnight at room temperature. The dried powder was ground with a pestle and annealed at 400° C. for 12 h in a muffle furnace to obtain the dark-green CoOₓ—SiO₂ powder.

### Synthesis of CuOₓ—SiO₂

180 mg of fumed SiO₂ powder was dispersed into 30 mL of water by sonication. 48 mg of copper (II) nitrate hydrate was dissolved into 20 mL of ammonia solution (the concentration of NH₃·H₂O was 5 mol/L). Under rigorous stirring, the Cu precursor solution was quickly injected into the SiO₂ solution. The mixture was aged under stirring for 1 h and then the blue precipitate was collected by vacuum filtration. Then the resultant Cu—SiO₂ precipitates were removed for air dry overnight at room temperature. The dried powders were ground with a pestle and annealed at 400° C. for 12 h in a muffle furnace to obtain the final dark-green CuOₓ—SiO₂ powder.

### Synthesis of FeOₓ—SiO₂

180 mg of fumed SiO₂ powder was dispersed into 50 mL of water by sonication. 40 mg of iron(III) nitrate was added into the SiO₂ solution. Under rigorous stirring, 0.2 mL of ammonia solution (the concentration of NH₃·H₂O was 2 mol/L) was quickly injected to the mixture solution. The mixture solution was aged under stirring for 1 h and then the orange precipitate was collected by vacuum filtration. Then the resultant Fe—SiO₂ precipitates were removed for air dry overnight at room temperature. The dried powder was ground with a pestle and annealed at 400° C. for 1 h in a muffle furnace to produce the final orange FeOₓ—SiO₂ powder.

### Synthesis of 0.05 wt % Pt₁/CeOₓ—SiO₂ Single-Atom Catalyst

300 mg of CeOₓ—SiO₂ powder was dispersed into 72 mL DI water under sonication for 20 min. Then the pH of the solution was adjusted to below 4 by using HCl (0.1 mol/L). 530 μL of platinum precursor solution (2.82 mg/mL of Pt) was diluted into 50 mL DI water and the pH was adjusted to below 4. Under rigorous stirring, the Pt precursor solution was slowly pumped into the CeOₓ—SiO₂ solution under stirring over 4 h. After aging under stirring for another 2 h, the precipitates were filtered using vacuum filtration and washed with DI water 3 times to remove any non-adsorbed ions and any other residue species. The resultant precipitates were dried in air overnight and then were calcined in air at 600° C. for 12 h.

### Synthesis of Reduced 0.05 wt % Pt₁/CeOₓ—SiO₂ Single-Atom Catalyst

300 mg of CeOₓ—SiO₂ powder was dispersed into 72 mL DI water under sonication for 20 min. Then the pH of the solution was adjusted to below 4 by using HCl (0.1 mol/L). 530 μL of platinum precursor solution (2.82 mg/mL of Pt) was diluted into 50 mL DI water and the pH value was adjusted to below 4. Under rigorous stirring, the Pt precursor solution was slowly pumped into the CeOₓ—SiO₂ solution under stirring over 4 h. After aging under stirring for another 2 h, the precipitates were filtered using vacuum filtration and washed with DI water 3 times to remove any non-adsorbed ions and any other residue species. The resultant precipitates were dried in air overnight and then were calcined in air at 600° C. for 12 h. Prior to catalytic CO oxidation reaction, the as-calcined catalyst was reduced in 10 sccm (standard cubic centimeter per minute) of 5% H₂/He at 300° C. for 1 h. Such reduced Pt₁/CeOₓ—SiO₂_SACs significantly improve CO oxidation activity.

Table 1 shows specific reaction rates of Pt (mmol CO/(gPt*s)) at different reaction temperatures.

TABLE 1
Specific reaction rates of Pt (mmol CO/(g_{Pt})*s)) at different
reaction temperatures

| Catalysts | 150° C. | 160° C. | 170° C. | Eₐ |
|---|---|---|---|---|
| 0.05 wt % Pt₁/CeOₓ—SiO₂ | 9.2 | 14.9 | 23.6 | −67.8 kJ/mol |
| 0.05 wt % Pt NPs/CeOₓ—SiO₂ | 0.46 | 1.1 | 1.8 | −79.3 kJ/mol |
| 0.05 wt % Pt/SiO₂ | 0.045 | 0.056 | 0.077 | −140 kJ/mol |
| CeOₓ—SiO₂ (control) | | | | |

The specific rates of Pt₁ atoms and Pt nanoparticles were measured with feed gas of 1.0 vol. % CO, 4.0 vol. % O₂ and He balance, pressure was 0.1 MPa. The apparent activationenergy (Eₐ) of the 0.05 wt % Pt₁/CeOₓ-SiO₂ single atom catalyst is the lowest, indicatingmost active. The conversion of CO over CeOₓ-SiO₂ (control) was practically zero at the reaction temperatures evaluated.

### Synthesis of 0.05 wt % Pd₁/CeOₓ—SiO₂ Single-Atom Catalyst

300 mg of CeOₓ—SiO₂ powder was dispersed into 72 mL DI water and the solution was then sonicated for 20 min. Then the solution pH was adjusted to below 4 using HCl (0.1 mol/L). 747 μL of palladium (II) chloride solution (2.0 mg/mL of Pd) was diluted into 50 mL DI water while the solution pH was maintained below 4. Under rigorous stirring, the Pd precursor solution slowly pumped into the CeOₓ—SiO₂ solution under stirring over 4 h. After aging under stirring for another 2 h, the resultant precipitates were filtered using vacuum filtration and washed with DI water for 3 times to remove non-adsorbed ions or other residue species. The precipitates were then dried in air overnight and further calcined in air at 400° C. for 3 h.

### Synthesis of 2 wt % Pt/CeOₓ—SiO₂ Cluster Catalyst

300 mg of CeOₓ—SiO₂ powders were immersed into 72 mL DI water under sonication for 20 min. The solution pH was maintained below 4 by using HCl (0.1 mol/L). 2.12 mL of platinum precursor solution (contains 2.82 mg/mL of Pt) was diluted into 50 mL DI water while maintaining the pH below 4. Under rigorous stirring, the Pt precursor solution was pumped into the CeOₓ—SiO₂ solution over 4 h. After aging (under stirring) for another 2 h, the precipitates were filtered using vacuum filtration and washed with DI water 3 times to remove non-adsorbed ions or other residue species. The precipitates were dried in air overnight at room temperature and were then calcined in air at 600° C. for 12 h. Finally, the 2 wt % Pt/CeOₓ—SiO₂ powders were reduced in 5 vol % CO at 400° C. for 5 h to produce uniformly distributed Pt nanoclusters that are attached to the CeOₓ nanoglues.

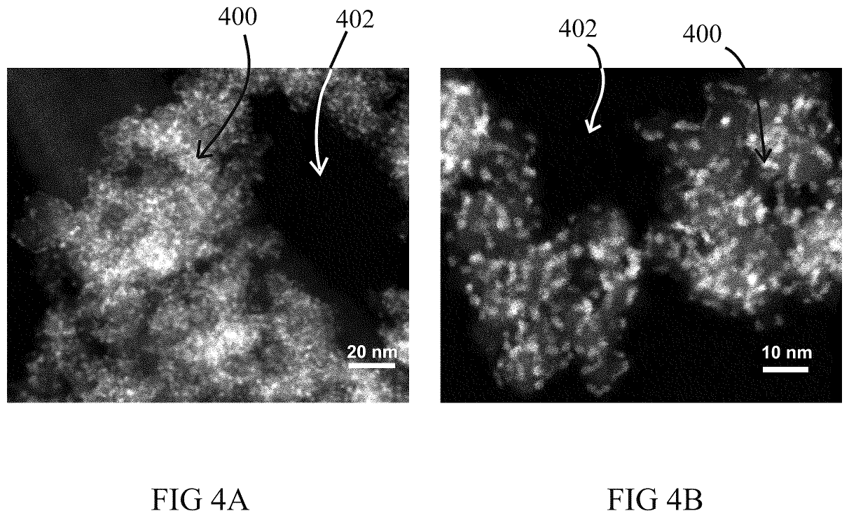

FIG. 4A shows a representative low-magnification high-angle annular dark-field-scanning transmission electron microscopy (HAADF-STEM) image of CeOₓ nanoislands 400 uniformly distributed throughout a high-surface-area SiO₂ support 402. FIG. 4B shows a representative high-magnification HAADF-STEM image of CeOₓ nanoislands 400, revealing the shape, size and spatial distribution of the CeOₓ nanoislands that are strongly attached to the SiO₂ surface 402.

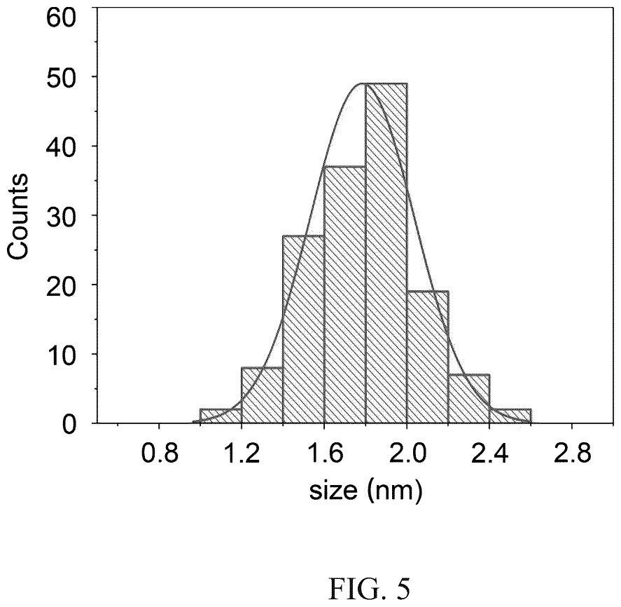

FIG. 5 shows a histogram of the particle size distribution of the CeOₓ nanoglues obtained by analyzing high resolution HAADF-STEM images. The average size of the CeOₓ nanoglues is ˜1.8 nm.

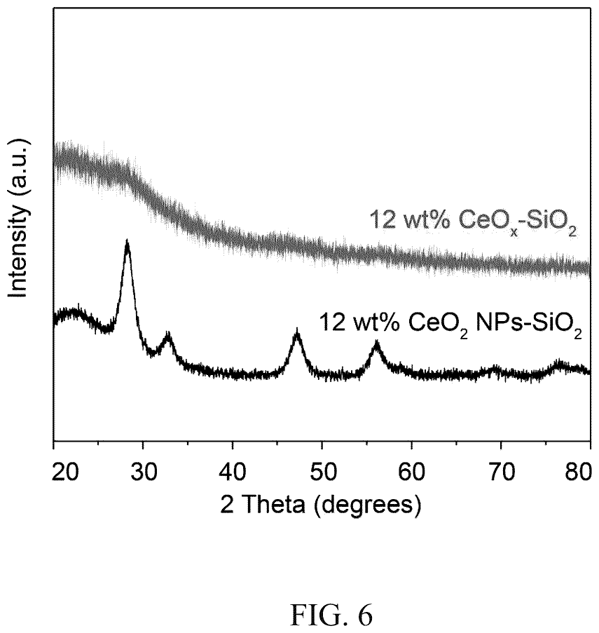

FIG. 6 shows powder X-ray diffraction (XRD) patterns obtained from defect-rich 12 wt % CeOₓ nanoglues (<3 nm) supported on SiO₂ and from stoichiometric 12 wt % CeO₂ nanoparticles (3-10 nm) supported on SiO₂. The sizes of the CeOₓ nanoglues are too small to give observable peaks in the XRD pattern while the larger CeO₂ nanocrystals show clearly recognizable peaks in the XRD pattern.

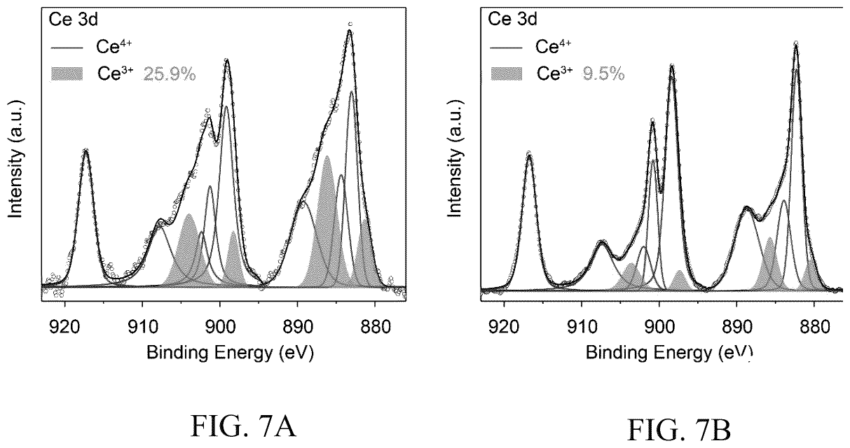

FIG. 7A shows Ce 3d X-ray photoelectron spectroscopy (XPS) spectra recorded over SiO₂ supported CeOₓ nanoglues. FIG. 7B show Ce 3d XPS spectra recorded over SiO₂ supported CeO₂ nanocrystals. The amount of Ce³⁺, reflecting the defect state, is more dominant in the CeOₓ nanoglues (˜26%) than that in the CeO₂ nanoparticles (˜10%).

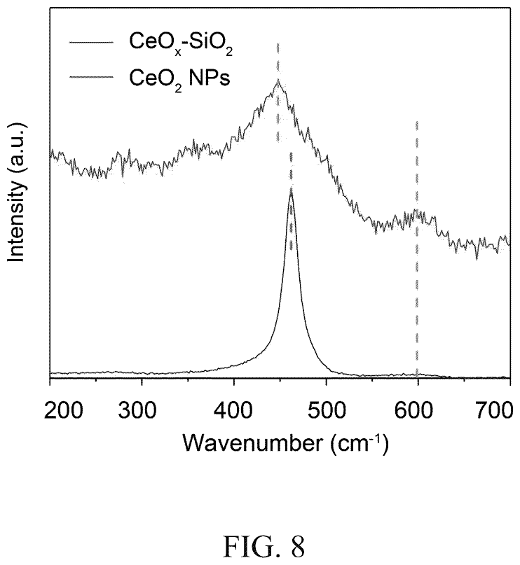

FIG. 8 shows Raman spectra obtained over SiO₂ supported CeOₓ nanoglues (upper) and CeO₂ nanocrystals (lower). Compared to the peak at 462 cm⁻¹ of CeO₂ nanoparticles (NPs), the corresponding peak of the 12 wt % CeOₓ—SiO₂ redshifts to 448 cm⁻¹ and becomes much broader, reflecting the increase in lattice constant due to their smaller sizes and the strong interaction between the CeOₓ nanoglues and the SiO₂ support.

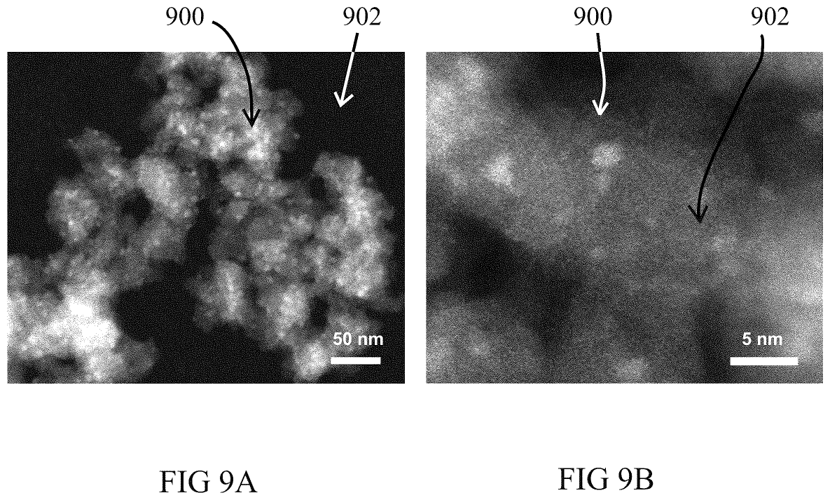

FIG. 9A shows a representative low-magnification HAADF-STEM image of CoOₓ nanoislands 900 uniformly distributed throughout the high-surface-area SiO₂ support 902. FIG. 9B shows a representative high-magnification HAADF-STEM image of CoOₓ nanoislands 900 showing the shape, size, and spatial distribution of the CoOₓ nanoislands attached to the SiO₂ surfaces 902.

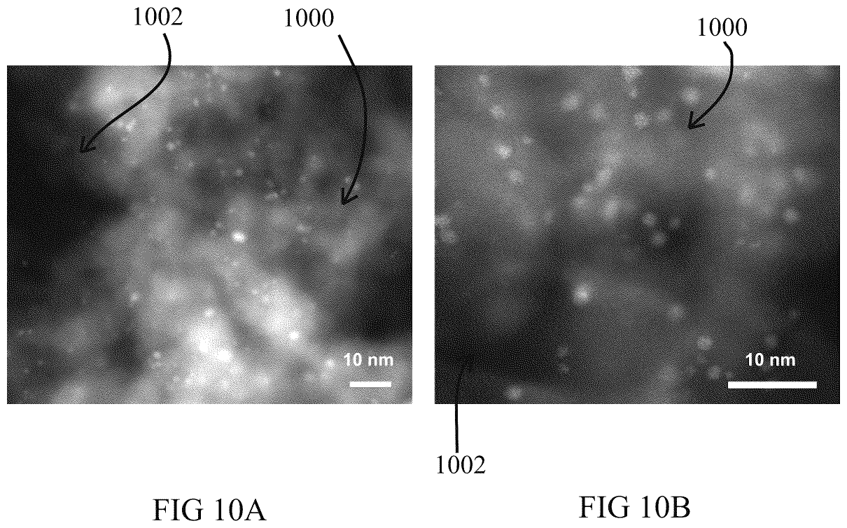

FIG. 10A shows a representative low-magnification HAADF-STEM image of CuOₓ nanoislands 1000 uniformly distributed throughout the high-surface-area SiO₂ support 1002. FIG. 10B shows a representative high-magnification HAADF-STEM image of CuOₓ nanoislands 1000 showing the shape, size, and spatial distribution of the CuOₓ nanoislands attached to the SiO₂ surfaces 1002.

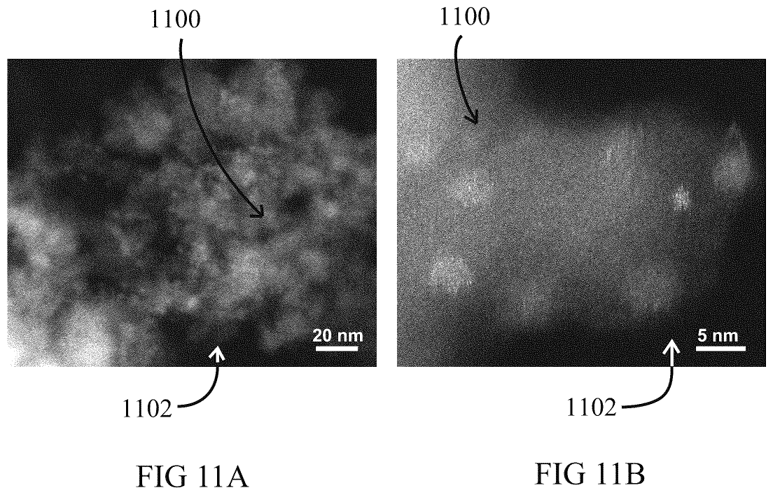

FIG. 11A shows a representative low-magnification HAADF-STEM image of FeOₓ nanoislands 1100 uniformly distributed throughout the high-surface-area SiO₂ support 1102. FIG. 11B shows a representative high-magnification HAADF-STEM image of FeOₓ nanoislands 1100 showing the shape, size, and spatial distribution of the FeOₓ nanoislands attached to the SiO₂ surface 1102.

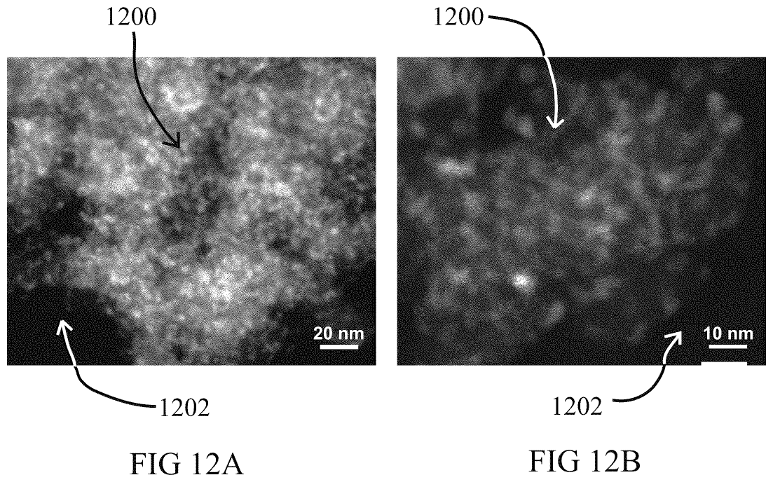

FIG. 12A shows a representative low-magnification HAADF-STEM image of a typical Pt₁/CeOₓ—SiO₂ single-atom catalyst 1200 revealing the absence of Pt nanoparticles and nanoclusters. FIG. 12B shows a representative high-magnification HAADF-STEM image of a typical Pt₁/CeOₓ—SiO₂ single-atom catalyst 1202 showing the absence of Pt nanoparticles and nanoclusters. Single Pt atoms cannot be reliably imaged because of the lack of image contrast since the atomic number differences between Pt and Ce is not large enough and that the thicknesses of the CeOₓ nanoislands change rapidly.

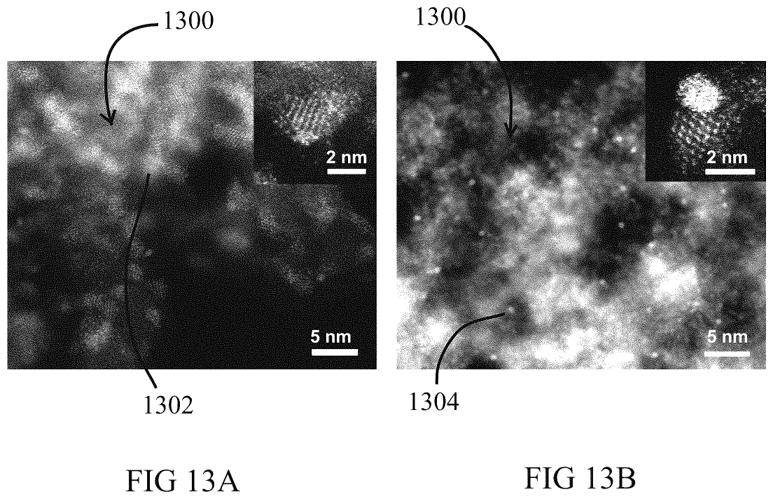

FIG. 13A shows a representative HAADF-STEM image of a typical CeOₓ—SiO₂ supported Pt cluster catalyst 1300 revealing the presence of many Pt nanoclusters 1302 with sizes ranging from ˜0.4 nm to 1.0 nm. FIG. 13B shows a representative HAADF-STEM image of a typical CeOₓ—SiO₂ supported Pt nanoparticle catalyst 1300 showing the presence of many Pt nanoparticles 1304 with sizes ranging from ˜0.5 nm to 2.0 nm.

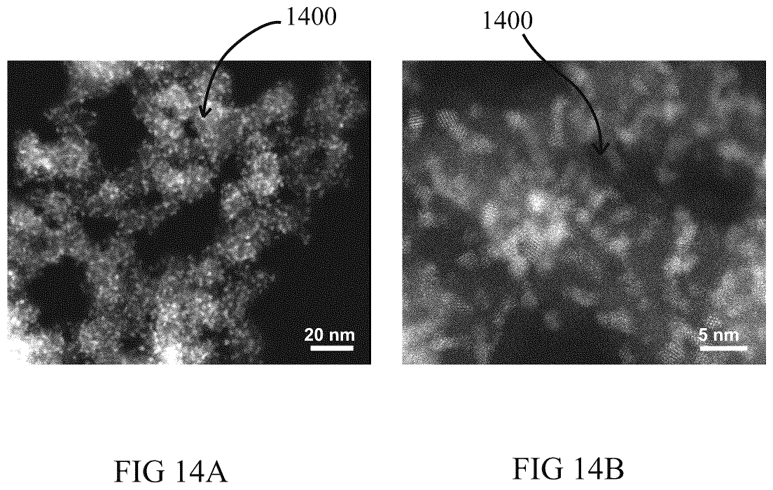

FIG. 14A shows a representative low-magnification HAADF-STEM image of a typical Pd₁/CeOₓ—SiO₂ single-atom catalyst 1400 showing the absence of Pd nanoparticles and nanoclusters. FIG. 14B shows a representative high-magnification HAADF-STEM image of a typical Pd₁/CeOₓ—SiO₂ single-atom catalyst 1400 showing the absence of Pd nanoparticles and nanoclusters. Single Pd atoms cannot be reliably imaged because of the lack of image contrast since the atomic number differences between Pd and Ce is small and that the thicknesses of the CeOₓ nanoislands change rapidly.

### CO Oxidation Reaction

The CO oxidation reaction over the fabricated catalysts was conducted in a fixed-bed plug-flow reactor at atmospheric pressure. Typically, 30 mg of catalyst was used for each catalytic test. For CO oxidation, the reaction temperature was ramped up with a heating rate of 1° C./min. The feed gas, containing 1 vol % CO, 4 vol % O₂ balanced with He, passed through the catalytic bed at a flow rate of 10.0 mL/min (corresponding to weight hourly space velocity (WHSV) of 20,000 mL/g·h). Outlet gas composition was measured by an online gas chromatograph (Agilent 7890A) equipped with a thermal conductivity detector (TCD).

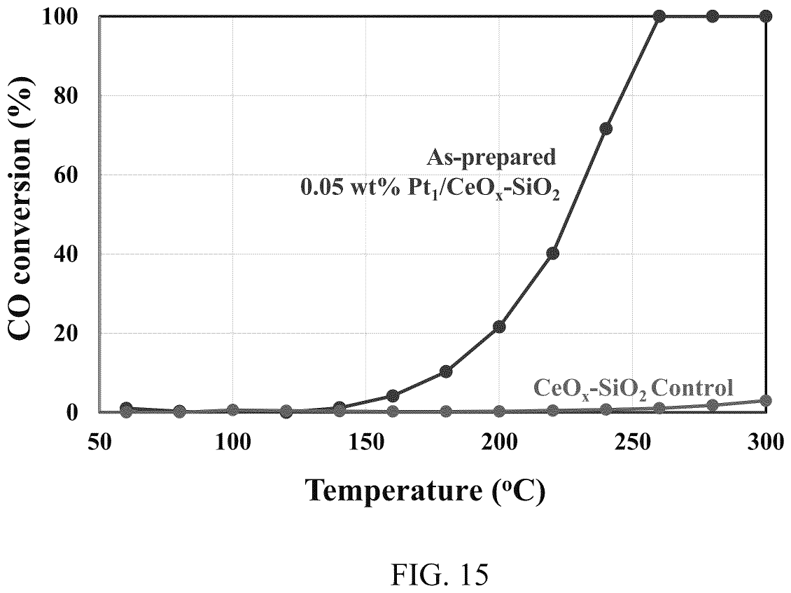

FIG. 15 shows conversion rate of CO oxidation over the 0.05 wt % Pt₁/CeOₓ—SiO₂ single-atom catalyst and the CeOₓ—SiO₂ support control. Reaction conditions: 1 vol % CO and 4 vol % O₂ balanced with He, pressure=0.1 MPa, space velocity=20,000 mL/g·h. The high CO oxidation activity originates from the Pt single atoms.

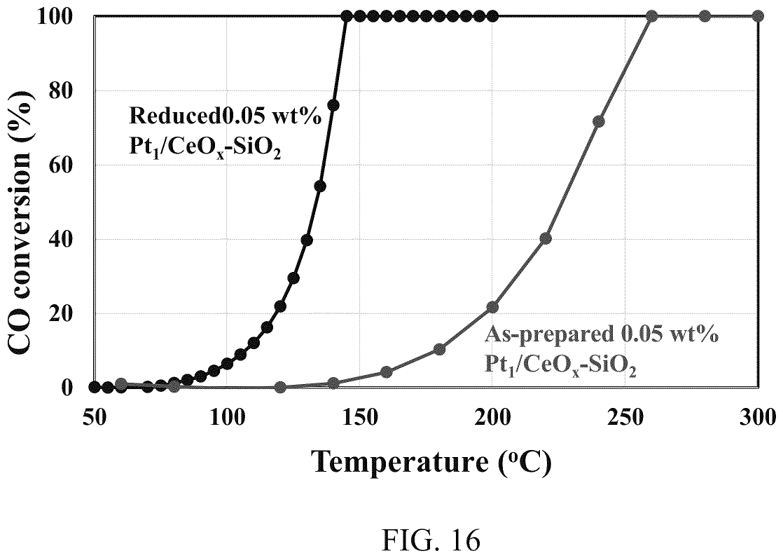

FIG. 16 shows conversion rate of CO oxidation over the 0.05 wt % Pt₁/CeOₓ—SiO₂ before and after H₂ reduction treatment. Reaction conditions: 1 vol % CO and 4 vol % O₂ balanced with He, pressure=0.1 MPa, SV=20,000 mL/g·h. The H₂ reduction process removes some oxygen ligands which are weakly bound to the Pt atoms. The reduction of the oxidation state of the Pt atoms promoted their CO oxidation activity. The modification of the CeOₓ by the H₂ reduction treatment may affect the observed CO oxidation activity as well.

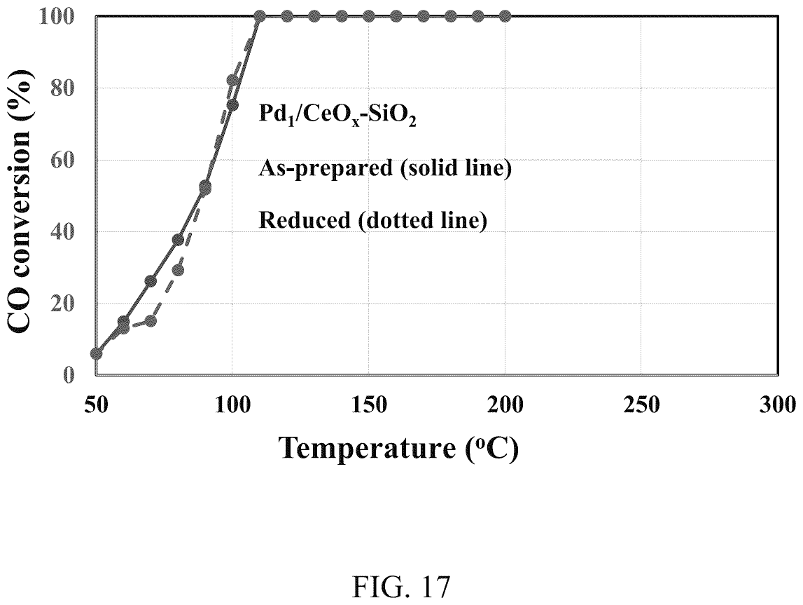

FIG. 17 shows conversion rate of CO oxidation over the 0.05 wt % Pd₁/CeOₓ—SiO₂ before and after H₂ reduction treatment. Reaction conditions: 1 vol % CO and 4 vol % O₂ balanced in He, pressure=0.1 MPa, SV=20,000 mL/g·h. The calcined 0.05 wt % Pd₁/CeOₓ—SiO₂ single-atom catalyst is intrinsically active for CO oxidation. The H₂ reduction process did not appreciably change the CO oxidation activity.

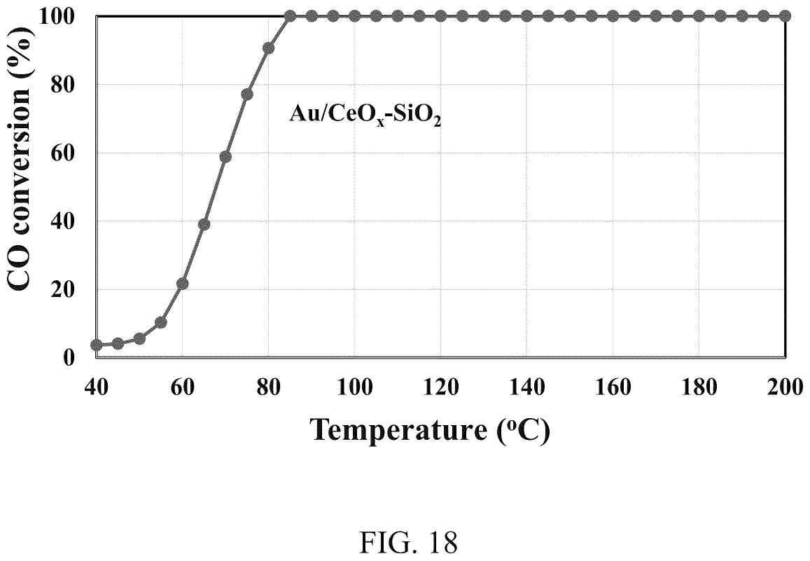

FIG. 18 shows conversion rate of CO oxidation over Au/CeOₓ—SiO₂ catalyst. Reaction conditions: 1 vol % CO and 4 vol % O₂ balanced with He, pressure=0.1 MPa, SV=20,000 mL/g·h.

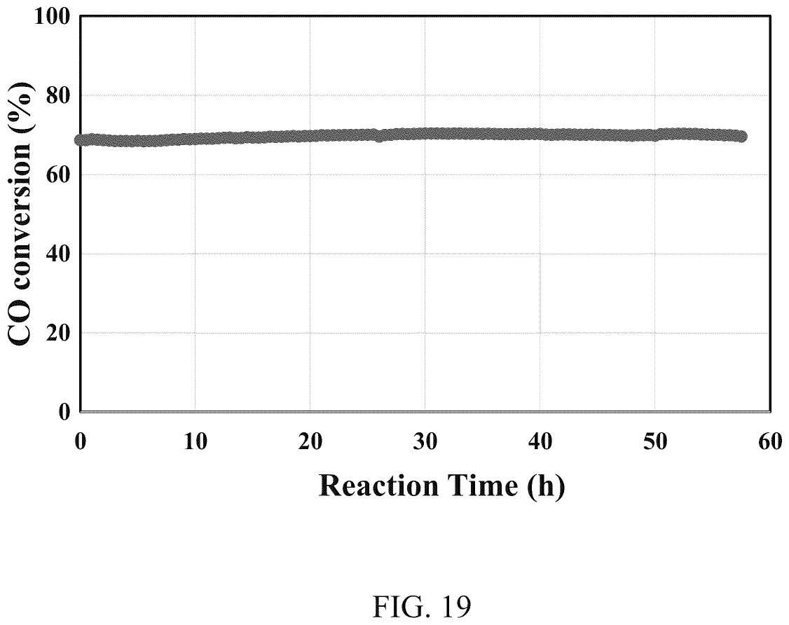

FIG. 19 shows a stability test of CO oxidation over the 0.05 wt % Pt₁/CeOₓ—SiO₂ single-atom catalyst. The CO oxidation reaction was conducted at 140° C. The 0.05 wt % Pt₁/CeOₓ—SiO₂ single-atom catalyst did not show any trend of deactivation during the long-term test. Reaction conditions: 1 vol % CO and 4 vol % O₂ balanced with He, pressure=0.1 MPa, SV=20,000 mL/g·h.

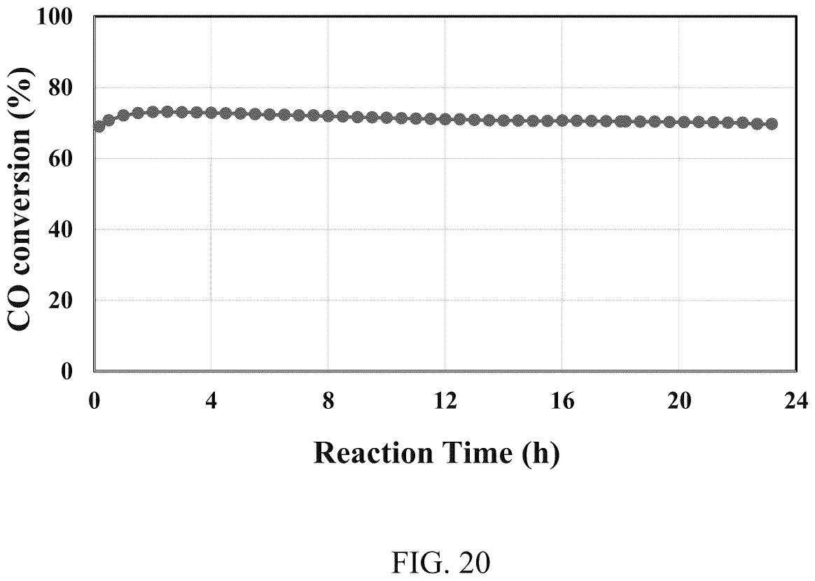

FIG. 20 shows a stability test for CO oxidation over the 0.05 wt % Pd₁/CeOₓ—SiO₂ single-atom catalyst. The CO oxidation reaction was conducted at 120° C. Reaction conditions: 1 vol % CO and 4 vol % O₂ balanced with He, pressure=0.1 MPa, SV=20,000 mL/g·h.

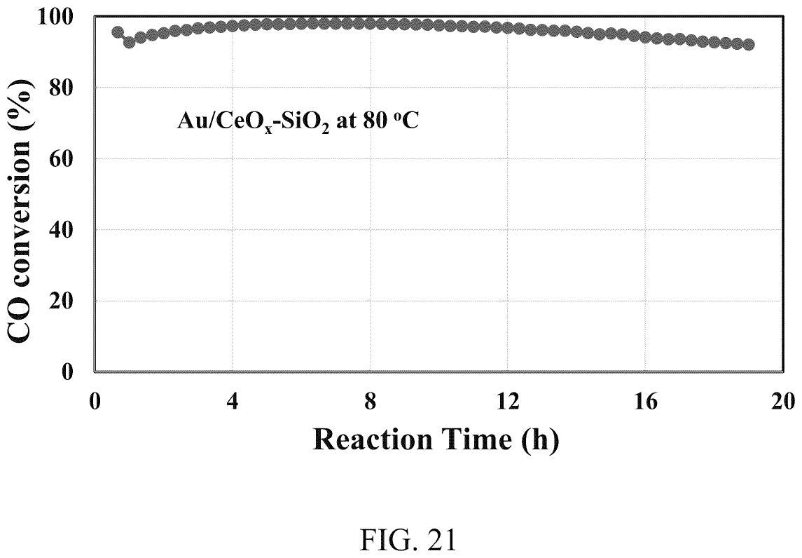

FIG. 21 shows a stability test for CO oxidation over the Au/CeOₓ—SiO₂ catalyst. The CO oxidation reaction was conducted at 80° C. Reaction conditions: 1 vol % CO and 4 vol % O₂ balanced with He, pressure=0.1 MPa, SV=20,000 mL/g·h.

### Water-Gas-Shift Reaction (WGS)

The WGS reaction over the fabricated catalysts was conducted in a fixed-bed plug-flow reactor at atmospheric pressure. Typically, 30 mg of catalyst was used for each test. Catalyst powders were pretreated in 10 sccm (standard cubic centimeter per minute) of 5% H₂/He at 300° C. for 1 h. The reaction temperature was ramped up with a heating rate of 2° C./min. The feed gas, containing 1 vol % CO balanced with He, passed through a water reservoir which was heated to 33° C. The gas mixture went through the catalytic bed at a flow rate of 10.0 mL/min (corresponding to a weight hourly space velocity (WHSV) of 20,000 mL/g· h). Outlet gas composition was measured by an online gas chromatograph (Agilent 7890A) equipped with a thermal conductivity detector (TCD).

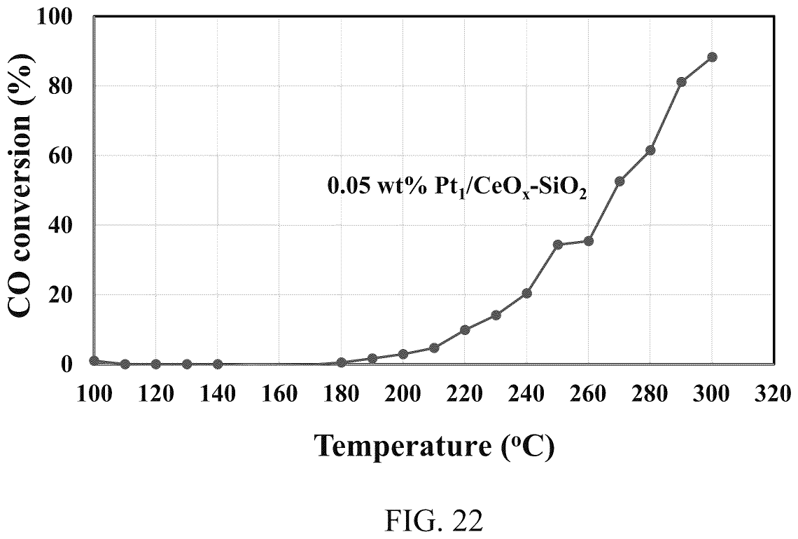

FIG. 22 shows conversion rate of WGS reaction over the 0.05 wt % Pt₁/CeOₓ—SiO₂ single-atom catalyst. Reaction conditions: 1 vol % CO and 5 vol % H₂O balanced with He, pressure=0.1 MPa, space velocity=20,000 mL/g·h.

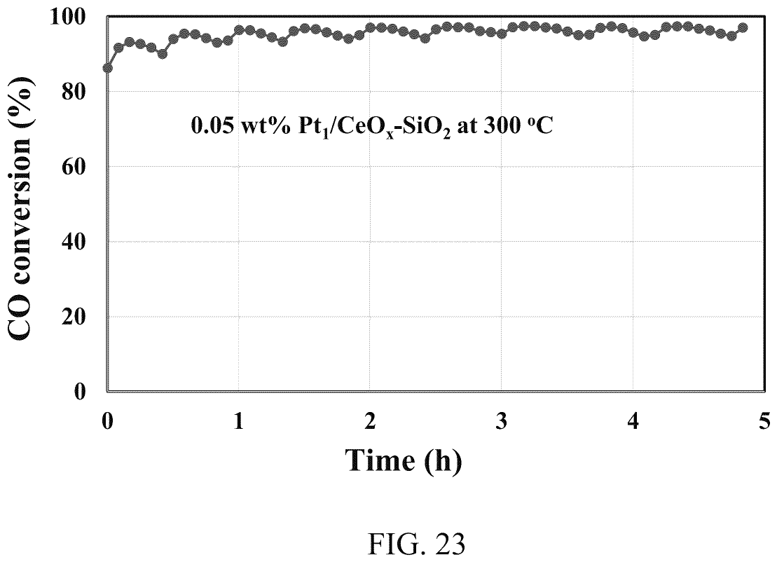

FIG. 23 shows a stability test of WGS over the 0.05 wt % Pt₁/CeOₓ—SiO₂ single-atom catalyst. The WGS reaction was conducted at 300° C. Reaction conditions: 1 vol % CO and 5 vol % H₂O balanced with He, pressure=0.1 MPa, space velocity=20,000 mL/g·h.

### Methane Combustion Reaction

The methane combustion reaction over the fabricated catalysts was conducted in a fixed-bed plug-flow reactor at atmospheric pressure. Typically, 30 mg of catalyst was used for each test. Before reaction test, the catalyst was pretreated with 10 sccm (standard cubic centimeter per minute) of 5% H₂/He at 300° C. for 1 h. For methane combustion, the reaction temperature was ramped up with a heating rate of 1° C./min. The feed gas, containing 1 vol % CH₄, 4 vol % O₂ balanced with He, passed through the catalytic bed at a flow rate of 10.0 mL/min (corresponding to a weight hourly space velocity of 20,000 mL/g·h). Outlet gas composition was measured by an online gas chromatograph (Agilent 7890A) equipped with a thermal conductivity detector (TCD).

### Methanol Reforming Reaction

The methanol reforming reaction over the synthesized catalysts was conducted in a fixed-bed flow reactor at atmospheric pressure. Typically, 30 mg of catalyst was used for each test. Before reaction, the catalyst was pretreated with 10 sccm (standard cubic centimeter per minute) of 5% H₂/He at 300° C. for 1 h. For methanol reforming reaction, the reaction temperature was ramped up with a heating rate of 1° C./min. The feed gas, containing 10 vol % CH₃OH, 7 vol % H₂O balanced with He, passed through the catalytic bed at a flow rate of 10.0 mL/min (corresponding to weight hourly space velocity of 20,000 mL/g·h). Outlet gas composition was measured by an online gas chromatograph (Agilent 7890A) equipped with a thermal conductivity detector (TCD).

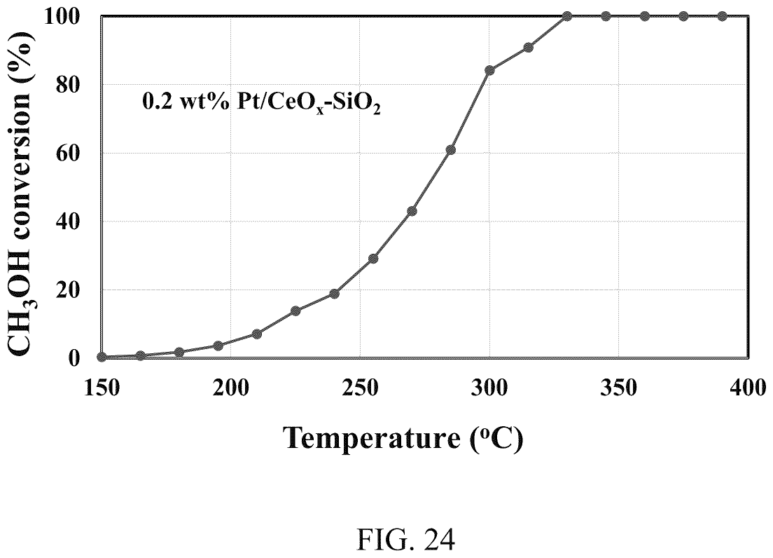

FIG. 24 shows a conversion rate for methanol steam reforming over the 0.2 wt % Pt/CeOₓ—SiO₂ catalyst. Reaction conditions: 1 vol % methanol and 1 vol % H₂O balanced with He, pressure=0.1 MPa, space velocity=20,000 mL/g·h.

### Synthesis of CeOₓ—SiO₂

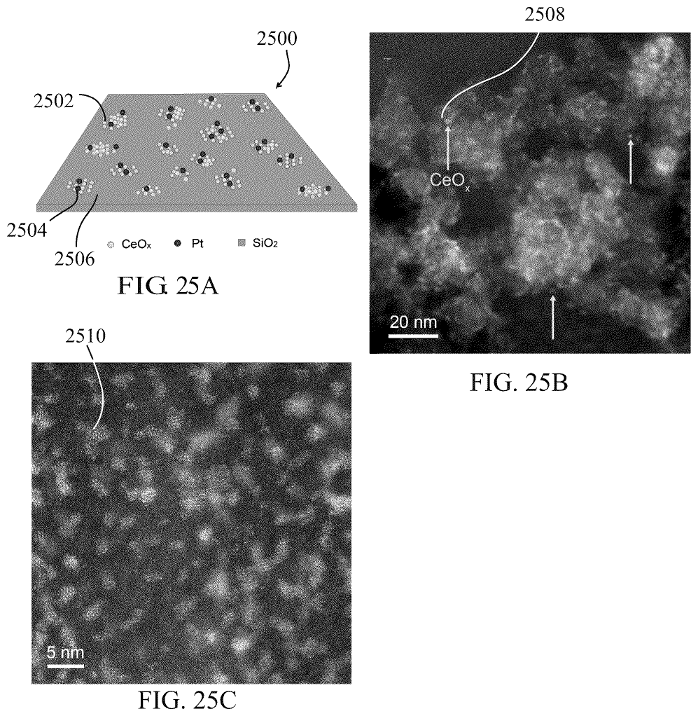

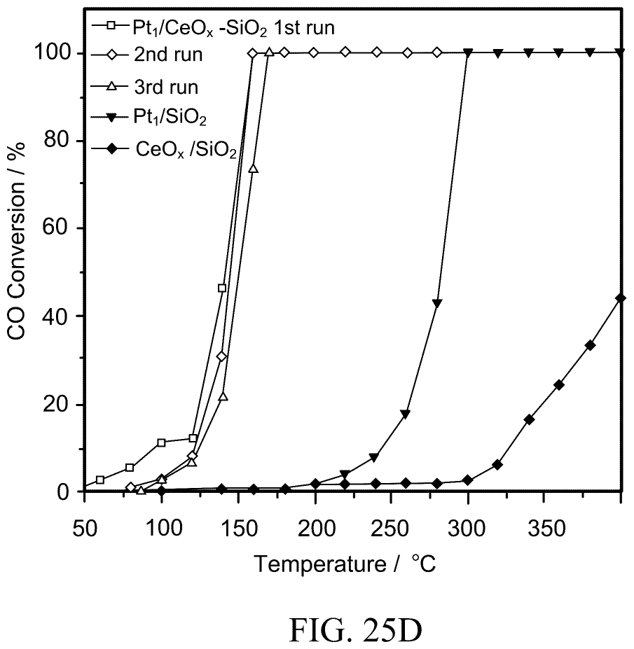

CeOₓ clusters were used as nanoglues to anchor Pt single atoms onto high surface area, inexpensive, and abundant SiO₂ supports, as depicted in FIG. 25A. The highly reducible CeOₓ clusters act as an oxygen gateway to store/release oxygen during selected catalytic reactions. CO oxidation was used as a probe reaction to test the catalytic performance of Pt₁/CeOₓ clusters dispersed onto SiO₂ nanoparticles.

180 mg of fumed SiO₂ powder (surface area of 278 m²/g) was mixed with 50 ml of water and then sonicated to obtain a uniform suspension. Under rigorous stirring, 86 mg of Ce(NO₃)₃·6H₂O was added into the SiO₂ solution. Subsequently, 0.4 mL of NH₃·H₂O (concentration 2 mol/L) was quickly injected into the mixed solution. After stirring for 3 min, the mixture was collected by vacuum filtration. The resultant light-brown Ce—SiO₂ precipitate was dried in air overnight at room temperature. The dried powder was ground with a pestle and then annealed at 600° C. for 12 h in a muffle furnace to obtain the light-yellow colored CeOₓ—SiO₂ powders. The loading of the CeOₓ was 12 wt % by inductively coupled plasma mass spectrometry (ICP-MS) measurement. Through the same procedure, the 6 wt % CeOₓ—SiO₂ was synthesized by using 43 mg of Ce(NO₃)₃·6H₂O and 0.2 mL of ammonia (2 mol/L). This synthesis process was successfully scaled up to 10 times, in which 1800 mg of SiO₂, 500 mL of H₂O, 860 mg of Ce(NO₃)₃·6H₂O and 4 mL of NH₃·H₂O were used, respectively.

A strong electrostatic adsorption method was used to disperse Pt salt precursors onto the surfaces of the as-prepared CeOₓ—SiO₂ nanocomposite powders. The Pt/CeOₓ—SiO₂ precipitates were then filtered, washed and dried at 60° C. for 5 h. The Pt₁/CeOₓ—SiO₂ powders, with a nominal loading of 0.05 wt. % of Pt, were calcined and/or reduced to form the final Pt₁ SACs.

FIG. 25A depicts high-number density CeOₓ—SiO₂ supported Pt₁ catalyst 2500, with platinum atoms 2502 on CeOₓ cluster 2504 and SiO₂ support 2506. FIG. 25B shows HAADF-STEM images of a typical Pt₁/CeOₓ—SiO₂ single-atom catalyst showing spatial distribution of the CeOₓ nanoislands 2508. FIG. 25C shows the atomic structure of the CeOₓ clusters 2510. The Pt₁ atoms cannot be reliably identified due to lack of proper image contrast. FIG. 25D shows catalytic testing data for CO oxidation. The conversion rates for the Pt₁/SiO₂ and the CeOₓ—SiO₂ controls were displayed as well. Reaction conditions: 1 vol % CO and 4 vol % O₂ balanced with He, pressure=0.1 MPa, SV=20,000 mL/g·h.

FIG. 25B shows representative HAADF-STEM images of the as-synthesized

Pt₁/CeOₓ—SiO₂ SAC. The bright patches (indicated by the yellow arrows) represent uniformly dispersed CeOₓ clusters with an average size of ˜2 nm and Pt nanoclusters are not observable. DRIFTS and EXAFS results show that the Pt species exists as isolated single Pt atoms. The Ce 3d XPS spectrum of the Pt₁/CeOₓ—SiO₂ SAC reveal enrichment of oxygen vacancies in the CeOₓ nanoclusters since the Ce³⁺/(Ce⁴⁺+Ce³⁺) ratio is 26% (FIG. 7A) vs 10% for CeO₂ nanocrystals (FIG. 7B). CO oxidation over the as-synthesized Pt₁/CeOₓ—SiO₂ SAC demonstrates that the CeOₓ anchored Pt₁ atoms are not only highly active but extremely stable during the three reaction cycles (FIG. 25D). The CO-DRIFTS results of the used Pt₁/CeOₓ—SiO₂ SAC demonstrate that the localized Pt₁ atoms did not sinter and maintained their catalytic property during the CO oxidation reaction. The crystalline nature and the dispersion of the CeOₓ clusters are clearly shown in FIG. 25C. Some small CeOₓ clusters are almost atomically dispersed and do not possess a crystalline phase. Although it is difficult to distinguish single Pt atoms from those of the highly dispersed Ce atoms/clusters we have not detected, in the as-prepared and used SACs, any Pt particles/clusters which are distinguishable from the CeOₓ clusters. FIG. 25D shows the catalytic testing data clearly demonstrating the high activity and stability of the Pt₁/CeOₓ—SiO₂ SAC for the CO oxidation reaction.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1.-21. (canceled)

22. A method of oxidizing CO, the method comprising:
contacting a feed gas comprising CO with a nanocomposite catalyst; and
oxidizing the CO to yield an outlet gas having a lower content of CO than the feed gas,
wherein the nanocomposite catalyst comprises:
a support;
a multiplicity of nanoscale metal oxide clusters coupled to the support; and
one or more metal atoms coupled to each of the nanoscale metal oxide clusters.

23. The method of claim 22, wherein the contacting occurs in a fixed-bed reactor.

24. The method of claim 23, wherein the fixed-bed reactor is a fixed-bed plug-flow reactor.

25. The method of claim 22, wherein the feed gas comprises O₂.

26. The method of claim 22, wherein 1-100 metal atoms are coupled to each of the nanoscale metal oxide cluster.

27. The method of claim 22, wherein the support is negatively charged, the nanoscale metal oxide clusters are positively charged, and the one or more metal atoms are negatively charged.

28. The method of claim 27, wherein the support is free of direct contact with the 1-100 metal atoms.

29. The method of claim 22, wherein the support comprises a refractory material having a surface area of at least 50 m²/g or at least 100 m²/g.

30. The method of claim 29, wherein the support comprises silica, alumina, magnesia, zirconia, cordierite, mullite, perovskite or any combination thereof.

31. The method of claim 29, wherein the support is powdered.

32. The method of claim 22, wherein the nanoscale metal oxide clusters comprise CeO₂, Co₃O₄, Fe₂O₃, TiO₂, CuO, NiO, MnO₂, Nb₂O₅, ZrO₂ or any combination thereof.

32. The method of claim 22, wherein the one or more metal atoms independently comprise one or more transition metal atoms.

33. The method of claim 28, wherein the one or more metal atoms independently comprise one or more precious metal atoms.

34. The method of claim 33, wherein the one or more metal atoms comprise Pt, Pd, Rh, Au, Ru, Ir, or any combination thereof.

35. The method of claim 22, wherein the support comprises SiO₂ and the metal oxide clusters comprise, CeO₂, Co₃O₄, CuO, Fe₂O₃, or any combination thereof.

36. The method of claim 22, wherein the nanoscale metal oxide clusters have a dimension in a range of 0.5 nm to 10 nm.

37. The method of claim 22, wherein the nanocomposite catalyst comprises a single platinum, palladium, or gold atom or a cluster of platinum, palladium, or gold atoms in contact with each nanoscale metal oxide particle.

38. The method of claim 37, wherein each nanoscale metal oxide particle is in contact with a silicon dioxide particle.

39. The method of claim 38, wherein the single platinum, palladium, or gold atom or the cluster of platinum, palladium, or gold atoms are free of direct contact with the silicon dioxide particle.

40. The method of claim 22, wherein the support is negatively charged and the nanoscale metal oxide clusters are positively charged.

41. The method of claim 40, wherein the single platinum or palladium atom or the cluster of platinum or palladium atoms are negatively charged.
